(19) United States
(12) Patent Application Publication
(10) Pub. No.: US 2024/0086621 A1
(43) Pub. Date: Mar. 14, 2024

(54) METHODS AND SYSTEMS TO SYNCHRONIZE TEXT IN TREE-STRUCTURED DOCUMENTS

(71) Applicant: Christopher J. Jerdonek, SAN FRANCISCO, CA (US)

(72) Inventor: Christopher J. Jerdonek, SAN FRANCISCO, CA (US)

(21) Appl. No.: 17/880,601

(22) Filed: Aug. 3, 2022

Related U.S. Application Data
(63) Continuation-in-part of application No. 17/719,308, filed on Apr. 12, 2022, now abandoned.
Application No. 17/719,308 is a continuation-in-part of application No. 16/992,102, filed on Aug. 13, 2020, now Pat. No. 11,334,644.
(60) Provisional application No. 62/886,738, filed on Aug. 14, 2019.
(60) Provisional application No. 62/886,765, filed on Aug. 14, 2019.
(60) Provisional application No. 62/886,758, filed on Aug. 14, 2019.

(51) Int. Cl. G06F 40/154; G06F 40/14; G06F 40/166

(52) U.S. Cl. CPC G06F 40/154; G06F 40/14; G06F 40/166

(57) ABSTRACT

In one aspect, a method for automatically implementing merging of online changes to a document tree of a web page document includes the step of providing a document tree T_{O} representing a web page document. The method includes the step of providing actors A and B. The method includes the step of detecting that actor A changes a copy of T_{O} to create a new document tree T_{A}. The method includes the step of detecting that actor B makes a different change to another copy of T_{O} to create a new document tree T_{B}. The method includes the step of flattening the document tree T_{O} (resp. T_{A} and T_{B}) to generate a sequence S_{O} (resp. S_{A} and S_{B}) of atoms, wherein each atom of the sequence comprises an individual character of the document tree T_{O} (resp. T_{A} and T_{B}). The method includes the step of synchronizing the content of the three document trees T_{O}, T_{A}, and T_{B} by creating new document trees T′_{O}, T′_{A}, and T′_{B} from them, respectively, so that T′_{O}, T′_{A}, and T′_{B} each flatten to a merged version of the sequences S_{O}, S_{A}, and S_{B} of atoms.

This application claims priority to and is a continuation in part of U.S. patent application Ser. No. 16/992,102, filed on 13 Aug. 2020, and titled METHODS AND SYSTEMS FOR THREE-WAY MERGES OF OBJECT REPRESENTATIONS. This application is hereby incorporated by reference in its entirety for all purposes.

U.S. patent application Ser. No. 16/992,102 claims priority from U.S. Provisional Application No. 62/886,738, filed 14 Aug. 2019. This application is hereby incorporated by reference in its entirety for all purposes.

U.S. patent application Ser. No. 16/992,102 claims priority from U.S. Provisional Application No. 62/886,765, filed 14 Aug. 2019. This application is hereby incorporated by reference in its entirety for all purposes.

U.S. patent application Ser. No. 16/992,102 claims priority from U.S. Provisional Application No. 62/886,758, filed 14 Aug. 2019. This application is hereby incorporated by reference in its entirety for all purposes.

### FIELD OF THE INVENTION

The invention is in the field of automated management of web page documents and more specifically to a method, system and apparatus for synchronizing text in tree-structured documents.

### BACKGROUND

The need for three-way merges can arise in any collaboration system that allows multiple independent sets of changes to be proposed to the same document, either asynchronously or at the same time. If different users independently propose different changes, there is often a desire to combine the changes. For example, say one has an initial tree-structured document like an HTML document. Person A then makes changes to that document, and Person B makes possibly different changes to the initial document. Combining these changes poorly can cause users' changes to be lost and other issues. Accordingly, there is a need for improved systems and methods of responding to and handling changes to tree-structured documents.

### SUMMARY OF THE INVENTION

In one aspect, a method for automatically implementing merging of online changes to a document tree of a web page document includes the step of providing a document tree T_{O} representing a web page document. The method includes the step of providing actors A and B. The method includes the step of detecting that actor A changes a copy of T_{O} to create a new document tree T_{A}. The method includes the step of detecting that actor B makes a different change to another copy of T_{O} to create a new document tree T_{B}. The method includes the step of flattening the document tree T_{O} (resp. T_{A} and T_{B}) to generate a sequence S_{O} (resp. S_{A} and SB) of atoms, wherein each atom of the sequence comprises an individual character of the document tree T_{O} (resp. T_{A} and T_{B}). The method includes the step of synchronizing the content of the three document trees T_{O}, T_{A}, and T_{B} by creating new document trees T′_{O}, T′_{A}, and T′_{B} from them, respectively, so that T′_{O}, T′_{A}, and T′_{B} each flatten to a merged version of the sequences S_{O}, S_{A}, and S_{B} of atoms.

In another aspect, a method for automatically implementing a merging of online changes to a document tree of a web page document includes the step of providing a document tree T representing the web page document. The method includes the step of flattening the document tree T to generate a sequence S of atoms, wherein each atom of the sequence comprises an individual character of the document tree T. The method includes the step of providing a patch P for S in response to one or more changes to the document tree T by one or more actors. The method includes the step of applying the patch P to the document tree T by applying each replacement in the patch P. The method includes the step of constructing for each replacement in the patch P a leaf node from a corresponding replacement sequence by taking as the children the sequence Q of atoms of the corresponding replacement sequence. The method includes the step of applying a replacement to the document tree T by removing from the document tree T the sequence S_{I} of atoms corresponding to an interval being replaced, and recursively removing any nodes that have zero children as a result, and then inserting a constructed leaf node at any point in the document tree T corresponding to where the sequence S_{I} of atoms and nodes were recursively removed. The method includes the step of constructing a new document tree T′ as a result, whose flattening equals a sequence S′ that results by applying the patch P to the sequence S.

### BRIEF DESCRIPTION OF THE DRAWINGS

FIG. 1 illustrates an example process for defining the term patch and related terms, according to some embodiments.

FIG. 2 illustrates an example process for defining tree-related terms, including document tree, according to some embodiments.

FIG. 3 illustrates an example process for generating a sequence of atoms from a document tree, or flattening the tree, according to some embodiments.

FIG. 4 illustrates an example process for applying a replacement to a document tree, according to some embodiments.

FIG. 5 illustrates an example process for applying a patch to a document tree, according to some embodiments.

FIG. 6 illustrates an example process for defining a 3-way merge function, according to some embodiments.

FIG. 7 illustrates an example process for constructing three patches given a 3-way merge function and three sequences of atoms, according to some embodiments.

FIG. 8 illustrates an example process for synchronizing text in tree-structured documents, according to some embodiments.

The Figures described above are a representative set and are not exhaustive with respect to embodying the invention.

### DESCRIPTION

Disclosed are a system, method, and article of manufacture for synchronizing text in tree-structured documents. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, markup languages, documents, software modules, user selections, network transactions, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. For example, various arrow types and line types may be employed in the flow chart diagrams. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Atom can be an individual character like a letter, number, or symbol. A special placeholder atom can be denoted as NULL.

Collaboration system is any website or other system that allows multiple users to collaborate together on editing the same web page document.

diff3 is a Unix utility to compare three text files and show any differences among them. diff3 can also merge text files, implementing a three-way merge.

Hypertext Markup Language (HTML) is the standard markup language for documents designed to be displayed in a web browser. HTML can be assisted by technologies such as Cascading Style Sheets (CSS) and scripting languages such as JavaScript, and it can incorporate multimedia elements like images and video by reference.

Markdown is a lightweight markup language with plain-text-formatting syntax.

Three-way merge can be the act of combining or merging two distinct sets of changes to an original representation of an object of a web page document to create a new representation. For example, there can be a document D containing a word W. Person A can make a change to a copy of D by changing the formatting of W, and Person B separately makes a change to a different copy of D by also changing the formatting of W, possibly in a different way. A three-way merge can provide a way of intelligently combining the changes to W made by A and the changes made by B, even though those changes were made to the same word. The result is a new formatting of the word W that incorporates the changes of both A and B.

Web page can be a specific collection of information provided by a website and displayed to a user in a web browser. A website can include a set of web pages linked together in a coherent fashion. An example web page can include one or more text files written in HTML. Additionally, web pages can use JavaScript code for dynamic behavior and CSS code for presentation semantics. A web page can include, inter alia: images, videos, and other multimedia files are also often embedded in web pages.

### Example Methods

A method of transforming certain tree-structured documents in response to independent changes to an initial tree-structured document is provided. Present methods modify all versions of the tree-structured document so the textual content of each matches the merged text.

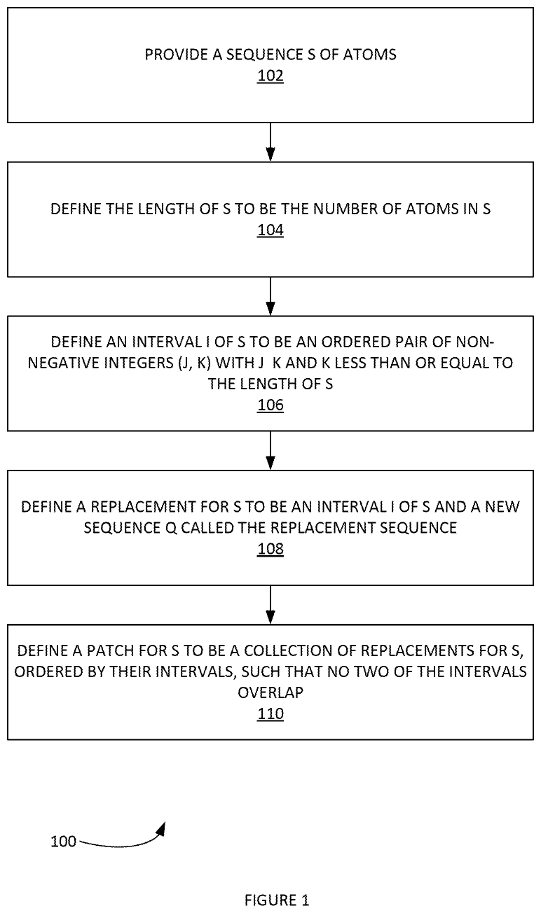

FIG. 1 illustrates an example process 100 for defining the term patch and related terms, according to some embodiments. In step 102, process 100 provides a sequence S of atoms. In step 104, process 100 defines the length of S to be the number of atoms in S. In step 106, process 100 can define an interval I of S to be an ordered pair of non-negative integers (j; k) with j k and k less than or equal to the length of S. An interval I of S gives rise to a consecutive subsequence of atoms of S by taking the first element to be the element with index j (interpreting j as a 0-based index) and the last element to be the element with index k−1 (again interpreting the index as a 0-based index). For example, the interval (0; 2) corresponds to the subsequence consisting of the first two elements. For the special case of j equal k, the subsequence can give rise to an empty sequence.

In step 108, given a sequence S of atoms, process 100 can define a replacement for S to be an interval I of S and a new sequence Q called the replacement sequence. Given a replacement for S with interval I equal to (j; k) and new sequence Q, the replacement gives rise to a new sequence S′ by removing the subsequence of atoms corresponding to I and inserting the atoms of the replacement sequence, in order, after the atom at the 0-based index j−1 (or, if j equals 0, at the beginning of the sequence).

In step 110, process 100 can, given a sequence S of atoms, define a patch for S to be a collection of replacements for S, ordered by their associated intervals, such that no two of the intervals overlap. Just as process 100 can apply a replacement given a replacement for S, given a patch for S, it can also refer to applying a patch to create a new sequence S′. This can be performed by applying each replacement in the patch in reverse order. Applying the replacements in reverse order lets us keep the indices of the intervals the same throughout the process, because this way the change resulting from a replacement doesn't affect the indices of the intervals of subsequent replacements.

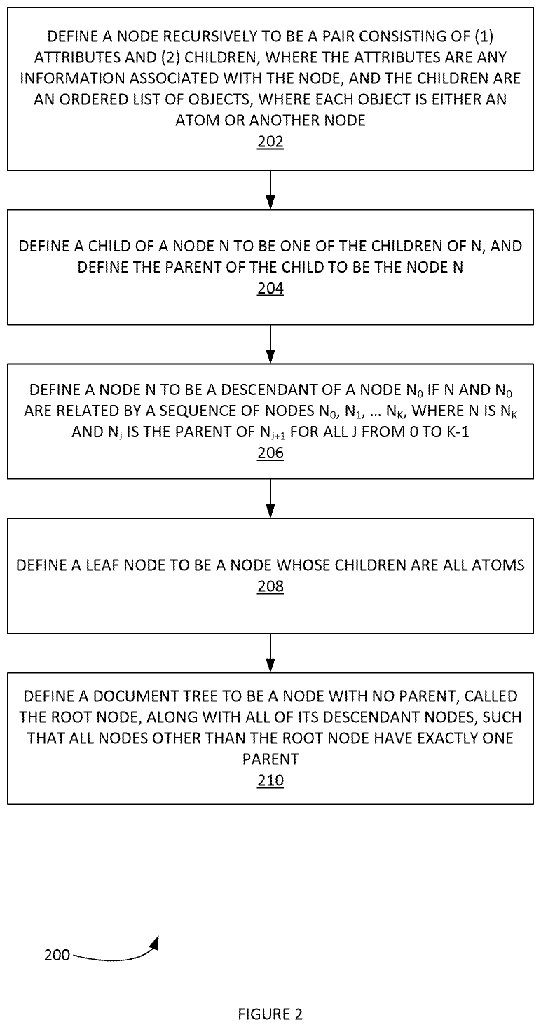

FIG. 2 illustrates an example process 200 for defining tree-related terms, including document tree, according to some embodiments. In step 202, process 200 defines a node recursively to be a pair consisting of (1) attributes and (2) children. The attributes can be any kind of information associated with the node. The information can include things like, inter alia, a name for the node, a label, a tag value, and a key-value mapping of additional information. The children are an ordered list of objects, where each object is either an atom or another node.

For example, let N₀ and N₁ be nodes; and say N₀ has four children a, b, N₁, and a, in order, where a and b are atoms (in this example letters). This relationship can be denoted using the following notation:

N₀=[a|b|N₁|a]

In step 204, process 200 defines a child of a node N to be one of the children of N and the parent of the child to be the node N. In step 206, given a node No, process 200 defines a node N to be a descendant of No if N and No are related by a sequence of nodes No, N₁, . . . Nₖ, where N is Nₖ and Nⱼ is the parent of Nⱼ₊₁ for all j from 0 to k−1.

In step 208, a leaf node is defined to be a node whose children are all atoms (or in particular has no children). In step 210, process 200 can define a document tree to be a node with no parent, called the root node, along with all of its descendant nodes, such that all nodes other than the root node have exactly one parent. In addition, by inserting a placeholder atom NULL as a child if needed, process 200 can assume without loss of generality that each node of a document tree has at least one child.

A document tree can be constructed from an HTML document or document fragment, for example, by first wrapping the HTML in a single root element, if necessary, and then replacing each HTML element with a node.

An example implemented by process 200 is now illustrated. Consider the following HTML fragment:
I<b>am<i>human</i></b>.

This can now be translated into a document tree with the following three nodes No, N₁, and N₂, with No as the root node:
N₀=[∥N₁|.]
N₁=[a|m∥N₂]
N₂=[h|u|m|a|n]

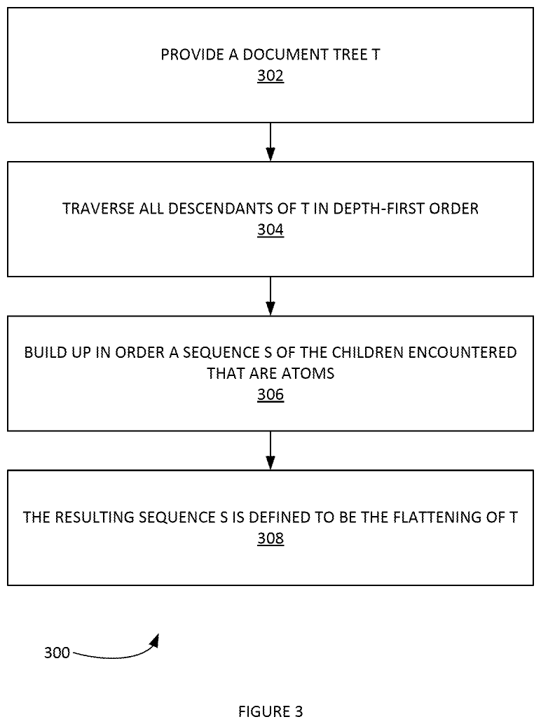

FIG. 3 illustrates an example process 300 for generating a sequence of atoms from a document tree, called “flattening the tree,” according to some embodiments. In step 302, process 300 provides a document tree T. In step 304, process 300 can traverse all descendants of T in depth-first order. In step 306, process 300 builds up, in order, a sequence S of the children encountered that are atoms. In step 308, process 300 defines the resulting sequence to be the flattening of T.

For example, for the example tree we described above, its flattening is
[I∥a|m∥h|u|m|a|n|.]

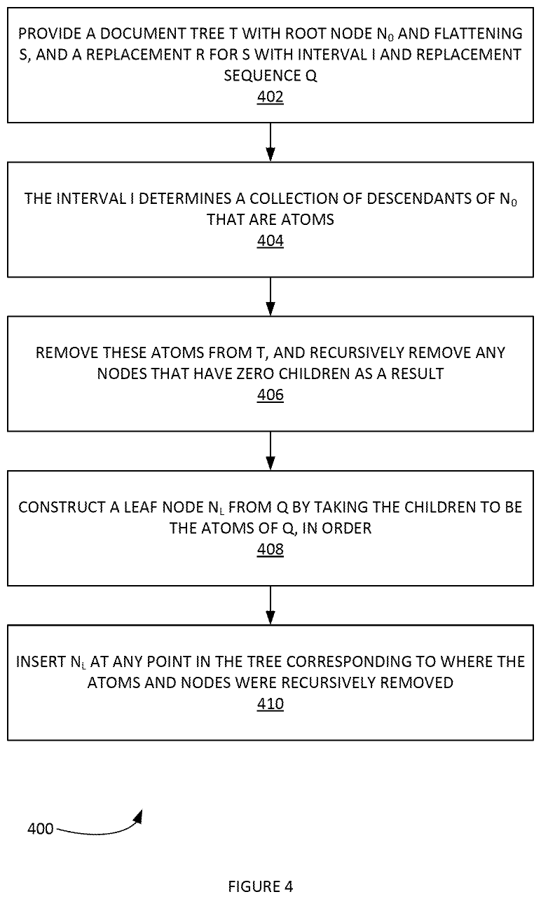

FIG. 4 illustrates an example process 400 for applying a replacement to a tree, according to some embodiments. In step 402, process 400 provides a document tree T with root node N₀ and flattening S, and a replacement R for S with interval I and replacement sequence Q. In step 404, process 400 determines from the interval I a collection of descendants of No that are atoms. In step 406, process 400 removes these atoms from T and recursively removes any nodes that have zero children as a result. In step 408, process 400 can construct a leaf node N_{L} from Q by taking as the children of N_{L} the atoms of Q, in order.

In step 410, process 400 can insert N_{L} at any point in the tree corresponding to where the atoms and nodes were recursively removed. There may be more than one location to choose from. For definiteness, process 400 can insert the leaf node as a child immediately after the child atom preceding the interval I. If no child atom precedes the interval (e.g. if the ordered pair for the interval was (0;j) for some integer j), then N_{L} can be inserted for example as the first child of the first leaf node in the tree (in depth-first order).

For example, for the “I am human” example supra, consider the replacement R defined by the interval (5; 10) and the replacement sequence: [h|e|r|e]. Observe that the interval (5; 10) corresponds to the following subsequence of atoms: [h|u|m|a|n]. Applying R to the example using process 400 results in the following as the new nodes:
N₀=[I∥N₁|.]
N₁=[a|m∥N₂]
N₂=[h|e|r|e]

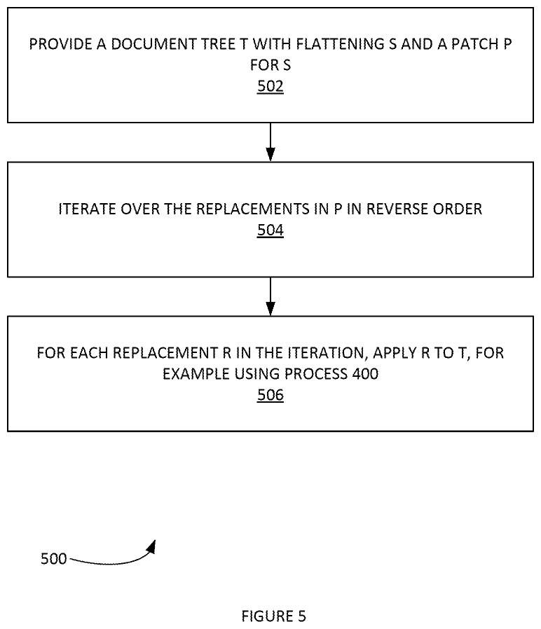

FIG. 5 illustrates an example process 500 for applying a patch to a document tree, according to some embodiments. In step 502, process 500 provides a document tree T with flattening S and a patch P for S. In step 504, process 500 can iterate over the replacements in P in reverse order. In step 506, for each replacement R in the iteration, the replacement R can be applied to T, for example using process 400.

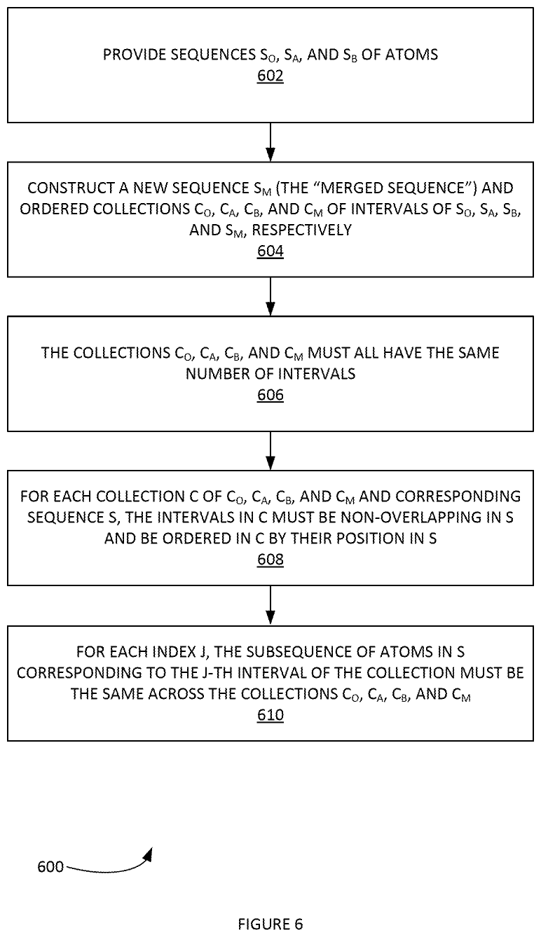

FIG. 6 illustrates an example process 600 for defining a 3-way merge function, according to some embodiments. In some embodiments, a three-way merge is the act of combining or merging two distinct sets of changes to an original object to create a new object. In step 602, process 600 provides sequences S_{O}, S_{A}, and S_{B} of atoms (e.g., corresponding to an original sequence, a changed version A of the sequence, and a changed version B, respectively). In step 604, a 3-way merge function can be defined as a function that takes as input S_{O}, S_{A}, and S_{B} and constructs a new sequence of atoms S_{M} (called the “merged sequence”), along with the additional information of four ordered collections of intervals C_{O}, C_{A}, C_{B}, and C_{M} of intervals of S_{O}, S_{A}, S_{B}, and S_{M}, respectively.

In steps 606 through 610, the four collections C_{O}, C_{A}, C_{B}, and C_{M} are set to have additional properties. Conceptually, the collections represent the portions of S_{O}, S_{A}, and S_{B} that the 3-way merge function found in common across the sequences and thus remain fixed, or unchanged, by the merge function in S_{M}. Steps 606 through 610 capture this conception. In step 606, process 600 requires that the collections C_{O}, C_{A}, C_{B}, and C_{M} all have the same number of intervals. In step 608, process 600 requires, in addition, that for each collection C of C_{O}, C_{A}, C_{B}, and C_{M} and its corresponding sequence S of atoms, the intervals in C are non-overlapping in S and ordered in C by their position in S. Finally, in step 610, process 600 requires that for each index j, the subsequence of atoms in S corresponding to the j-th interval of the collection are the same across the four collections C_{O}, C_{A}, C_{B}, and C_{M}.

The diff3 Unix utility for text files is an example of a 3-way merge function implementing process 600. For example, the collections of intervals C_{O}, C_{A}, and C_{B} in this case correspond to the regions of the input files that diff3 considers unchanged. Process 600 and the diff3 Unix utility can provide a source of examples for the subsequent processes 700 and 800 below.

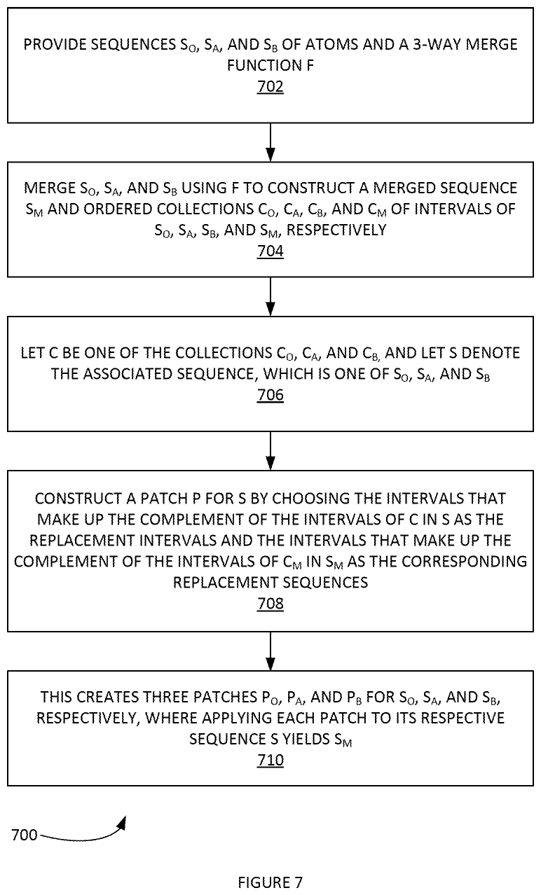

FIG. 7 illustrates an example process 700 for constructing three patches given a 3-way merge function and three sequences of atoms, according to some embodiments. In step 702, process 700 provides sequences S_{O}, S_{A}, and S_{B} of atoms and a 3-way merge function F. In step 704, process 700 merges S_{O}, S_{A}, and S_{B} using the merge function F to construct a merged sequence S_{M} and ordered collections C_{O}, C_{A}, C_{B}, and C_{M} of intervals of S_{O}, S_{A}, S_{B}, and S_{M}, respectively. Step 706 lets C be one of the collections C_{O}, C_{A}, and C_{B}, and it lets S denote the associated sequence, which is one of S_{O}, S_{A}, and S_{B}. In step 708, for this C, process 700 can construct a patch P for S by choosing the intervals that make up the complement of the intervals of C in S as the replacement intervals and the intervals that make up the complement of the intervals of C_{M} in S_{M} as the corresponding replacement sequences. In step 710, process 700 concludes with the creation of three patches P_{O}, P_{A}, and P_{B} for S_{O}, S_{A}, and S_{B}, respectively, where applying each patch to its respective sequence S yields S_{M}.

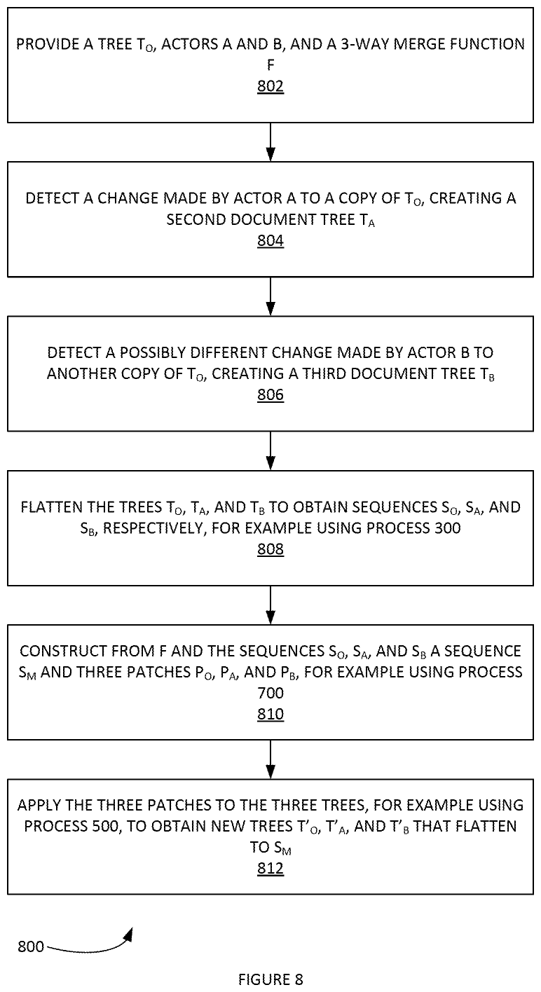

FIG. 8 illustrates an example process 800 for synchronizing text in tree-structured documents following changes to an original document, according to some embodiments, and using the definitions and methods provided in processes 100-700 as described supra. In step 802, process 800 provides a tree T_{O}, actors A and B, and a 3-way merge function F (e.g., the diff3 Unix utility). In step 804, process 800 detects actor A making a change to a copy of T_{O} to create a second document tree T_{A}. In step 806, process 800 detects actor B making a (possibly) different change to another copy of T_{O} to create a third document tree T_{B}. In step 808, process 800 can flatten the three trees to obtain sequences S_{O}, S_{A}, and S_{B}, for example using process 300. In step 810, the merge function F is applied to the three sequences to create a sequence S_{M} and three patches P₀, P_{A}, and P_{B}, for example using process 700. Each patch P has the property that applying it to its respective sequence S yields S_{M}. Step 812 concludes process 800 by applying the three patches to the three trees, for example using process 500, to obtain new trees T′_{O}, T′_{A}, and T′_{B} that flatten to S_{M}. In other words, the content of each tree is synchronized to the merged content S_{M}.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for automatically implementing merging of online changes to a document tree of a web page document, comprising the steps of:
providing a document tree T_{O} representing a web page document;
providing actors A and B;
detecting that actor A changes a copy of T_{O} to create a new document tree T_{A};
detecting that actor B makes a different change to another copy of T_{O} to create a new document tree T_{B};
flattening the document tree T_{O} (resp. T_{A} and T_{B}) to generate a sequence S_{O} (resp. S_{A} and S_{B}) of atoms, wherein each atom of the sequence comprises an individual character of the document tree T_{O} (resp. T_{A} and T_{B});
synchronizing the content of the three document trees T_{O}, T_{A}, and T_{B} by creating new document trees T′_{O}, T′_{A}, and T′_{B} from them, respectively, so that T′_{O}, T′_{A}, and T′_{B} each flatten to a merged version of the sequences S_{O}, S_{A}, and S_{B} of atoms.

2. The method of claim 1 further comprising:
providing a 3-way merge function F;
constructing the merged version of the sequences S_{O}, S_{A}, and S_{B} of atoms by applying the 3-way merge function F to S_{O}, S_{A}, and S_{B} to construct a merged sequence S_{M};

3. The method of claim 2 further comprising:
constructing three patches P_{O}, P_{A}, and P_{B} for S_{O}, S_{A}, and S_{B}, respectively, after applying the 3-way merge function F, such that applying each patch to its respective sequence S yields S_{M};
constructing T′_{O}, T′_{A}, and T′_{B} by applying the three patches P_{O}, P_{A}, and P_{B} to the three trees T_{O}, T_{A}, and T_{B}, respectively.

4. The method of claim 3 further comprising:
applying a patch to a document tree by applying each replacement in the patch.

5. The method of claim 4 further comprising:
applying a replacement to a document tree by removing from the tree the atoms corresponding to the interval being replaced, and recursively removing any nodes that have zero children as a result;
constructing a leaf node from the replacement sequence of the replacement by taking as the children the atoms of the replacement sequence;
inserting the leaf node at any point in the document tree corresponding to where the atoms and nodes were recursively removed.

6. The method of claim 1, wherein either or both of the actors A and B change a copy of T_{O} by using an editing tool instantiated in a web browser.

7. The method of claim 1 further comprising:
wherein the web page document comprises a document in an online collaboration system;
wherein the plurality of changes being merged correspond to multiple edits to the document in the online collaboration system.

8. The method of claim 7 further comprising:
wherein the online collaboration system is for a collaboratively edited online encyclopedia;
wherein the document comprises an encyclopedia article in the collaboratively edited online encyclopedia.

9. The method of claim 1, wherein an atom comprises an individual character comprising a letter character, a number character, a symbol character or a NULL.

10. The method of claim 2, wherein the three-way merge function comprises the diff3 utility.

11. A method for automatically implementing a merging of online changes to a document tree of a web page document, comprising the steps of:
providing a document tree T representing the web page document;
flattening the document tree T to generate a sequence S of atoms, wherein each atom of the sequence comprises an individual character of the document tree T;
providing a patch P for S in response to one or more changes to the document tree T by one or more actors;
applying the patch P to the document tree T by applying each replacement in the patch P;
constructing for each replacement in the patch P a leaf node from a corresponding replacement sequence by taking as the children the sequence Q of atoms of the corresponding replacement sequence;
applying a replacement to the document tree T by removing from the document tree T the sequence S_{I} of atoms corresponding to an interval being replaced, and recursively removing any nodes that have zero children as a result, and then inserting a constructed leaf node at any point in the document tree T corresponding to where the sequence S_{I} of atoms and nodes were recursively removed;
constructing a new document tree T′ as a result, whose flattening equals a sequence S′ that results by applying the patch P to the sequence S.
